(19) United States
(12) Patent Application Publication
(10) Pub. No.: US 2008/0313527 A1
(43) Pub. Date: Dec. 18, 2008

(54) Region-based controlling method and system for electronic documents

(75) Inventor: Jing Chen, Beijing (CN)

Correspondence Address: MICHAEL N. LAU;LAU & ASSOCIATES, LLC, 2121 EISENHOWER AVENUE, SUITE 200, ALEXANDRIA, VA, 22314, US

(73) Assignee: CleNET TECHNOLOGIES (BEIJING) CO., LTD.

(21) Appl. No.: 11/896,954

(22) Filed: Sep. 7, 2007

(30) Foreign Application Priority Data
Jun. 15, 2007 (CN) 200710111174.5

(51) Int. Cl. G06F 15/00

(52) U.S. Cl. 715/200

(57) ABSTRACT

The invention provides a region-based controlling method and system of electronic documents. In this method, the electronic document is first encapsulated within a virtual “container”, forming a new electronic file (system), which contains at least a region judgment module, used to judge the current location of the document, and contains a play/display module that controls the status of playing or displaying the document. When the document needs to be played or displayed, the play/display module sends the request to the region judgment module to confirm the current location, and the region judgment module sends the region Authentication request to the region server via the terminal device. After the region authentication session finishes, the response from the region server is received by the terminal device. If the response indicates that the terminal device is within the authorized region, the play/display module will continue to play or display the document, and otherwise the play/display module will reject the request to open the document. By this invention, unauthorized copy and propagation of electronic files can be prevented.

### TECHNICAL FIELD

The invention relates to a method and system that can effectively control the usage and transmission of electronic documents, which are especially text archives, pictures and video clips that are easy to be copied and transmitted via network.

### BACKGROUND OF THE INVENTION

Nowadays, information resource is a core part of invisible asset of the enterprises, and it is more and more important. Information could be carried via all kinds of documents, such as archives (with suffix “.txt”, “.doc” . . . ), pictures (with suffix “.bmp”, “.jpg” . . . ), video clips (with suffix “.avi”, “.wmv” . . . ) and etc. These documents are very easy to be copied and spread. The controlled target document is floating, which means it can still be copied and transmitted out to anywhere but will be readable only within the preset region. Moreover, to meet the requirement of data sharing and collaboration, the information systems have many potential security issues, due to their open OS and network protocols. The confidential file containing business secrets and/or technical secrets could be leaked out if there is no suitable controlling mechanism. Therefore, to protect confidentiality, integrity and availability becomes one the demands of the highest priority.

To meet the requirements mentioned above, there are lots of solution that have been developed, among which is Digital Right Management (DRM). By DRM, user's device has been authorized to use the specific document, or in another word, DRM technology is based on the devices' identification. But this kind of secure mechanism still can't solve this issue: when the user brings his/her device out of the secure area (e.g., out of the office), it is efficient to control that this content of the document in the device will not be leaked out.

In practice, restricting the area of usage for the document is necessary, because some top secret files should only be readable within the office, but never out of the office (like in the home). The traditional way of dealing with these files is to store them centrally (for example in the server of the company) and to disallow any kind of copying and transmitting. In this kind of system, once the copying has been done, the thief will have the total control of the copied file, and there is no way of remedy. Anyway the above method is quite old-fashioned and inconvenient for the user, and we believe it will be very user-friendly if we could allow users to save documents into their laptops while still keeping the desired security features.

There used to be a method and system that utilizes GPS to control access of resources, but the space of offices or buildings are not so regular and it is a bit difficult to define the borders precisely and well. Moreover, the method could not solve the issue of unauthorized propagation of files.

In the China patent application with public number CN1818919A, a method and system for permission control and authentication of electronic documents was presented, which can allow protected documents to be readable at any place, while disable readability for unauthorized document. The technical solution for that invention is: The user connect the device, that carries the protected documents, to a computer. Therefore the device becomes a client, with an unique hardware ID. The user input the user information into the computer, and the client will submit the hardware ID, user information and the document ID to the server, and the server will check the mapping table stored on its database, to check if the user has the permission: if not, then lock the right to read the document.

In the China patent application with public number CN1284088C, a access control system was given, where the device of the terminal user is requested to send the stored data to another device, the system will control. The system consists of client devices and the server. The server can communicate with client devices and manage the access control list. The server consists of the module for judgment on enabling or disabling access, running per request from the client. The client device consists of Query (on permission) module and transmission module. When other device request it to transmit its data out, it will query the permission and will transmit the data only after the query results show that the transmission is allowed.

### SUMMARY OF THE INVENTION

The invention is to provide a region-based controlling method and system for electronic documents. The method and the system can effectively restrict the access of the document within a specific area. Once the document is moved out of the area, it will become unreadable.

To achieve the target, the invention adopts the following technical solution:

An electronic file system, which we also call it a “container” system, whose features contains:

A region judgment module, which is used to check and verify the current location of the system;

A play/display module, which is used to control the status of displaying or playing documents contained within file system;

An electronic document, encrypted and encapsulated within the file system, controlled by the play/display module.

The region judgment module is connected with the play/display module. When the region judgment module detects that the document is not within the authorized region, it will notify the play/display module to disable or stop the playing/displaying the document.

The authorized region mentioned above is the preset local area network.

The electronic file system also contains an anti-copy module that can prevent any copy operation by users.

The electronic file system also contains a timer module that will trigger the region judgment module and the play/display module recursively (regularly).

The timer module is connected with the region judgment module and the play/display module.

The region-based controlling system for electronic documents has the following features:

The controlling system contains at least one region server, 1 or more terminal devices connected with region server, and the electronic file systems in claim 1 are stored within these terminal devices.

When the terminal device connects the region server, the region judgment module communicates with the server via the terminal device. The region server can judge whether the device is within the authorized region by its device ID and current access point/address.

The region-based controlling system for electronic documents, based on the above implementation of electronic file system and controlling system, has the following features:

The document to be protected should be encapsulated within the electronic system;

When the content of the document needs to be displayed or played, the play/display module sends the request to the region judgment module to verify if the terminal device containing this electronic file system is within the authorized region;

Each time when the terminal device is connected to the local network, the region server of the local network will identify if the terminal device is authorized by its device ID and its current access point (e.g. its current IP address), and the region server will send a nonce (a random number) to the terminal device.

When the region judgment module is requested to verify if the terminal device containing this electronic file system is within the authorized region, it will initialize an authentication session with the preset region server. During the session, the terminal device challenge the region server by using its own device identifier together with its current access point and the nonce received from the region server in the current connection.

The region server will then determine if this terminal device is authorized within the current region by the received device ID, access point and the nonce (checking if the nonce is equal to the one the region server has sent to this terminal device at the beginning of the connection). If all the checking has been passed correctly, the region server will respond that the terminal device is a authorized device permitted in this region.

If the session ends successfully, which means that the terminal device is within the authorized region, the region judgment module will notify the play/display module to display or play the document within the system, otherwise it will reject the request of displaying or playing the document.

To ensure security, the communication between the region server and the terminal devices could be encrypted by the public key of the target receiver and signed by using its own private key.

When the document is being played/displayed, any operation that intends to copy the content is forbidden by the anti-copy module.

The electronic file system also contains a timer module, which sends the request recursively (i.e., every other a short time period) to the play/display module and region judgment module to verify if the terminal device is still within the authorized region.

When the document is being played/displayed, if the region judgment module discovers that the terminal device is out of the region, the play/display module will get notified. After that, the play/display module may send a prompt to the user warning that he should go back to the region within a given short time duration, otherwise the playing or displaying of the document will be closed right now or after this given time expired.

Using the method or system provided by this invention, electronic files can be visible only within given regions. Within the given region, the files can be freely read, played, displayed and moved (copying and moving of the whole “container” is always possible, and the anti-copy module is to prevent from any copying of the encrypted document inside the “container”), but once leaving the region, the document encapsulated within the file system will never be accessible. Therefore, it will be useless even you copy the whole file system (the “container”) and take it away.

### BRIEF DESCRIPTION OF THE DRAWINGS

While the appended claims set forth the features of the present invention with particularity, the invention, together with its objects and advantages, may be best understood from the following detailed description taken in conjunction with the accompanying drawings of which:

FIG. 1 is a block diagram generally illustrating a document is encapsulated inside the “container” (the electronic file system);

FIG. 2 is a block diagram generally illustrating an internal structure of the “container”;

FIG. 3 is a block diagram generally illustrating a topology of a region, consisting of a region server and several terminal device;

FIG. 4 is a block diagram generally illustrating a sequence diagram showing how an authentication could be used between the terminal device and the region server.

### DETAILED DESCRIPTION

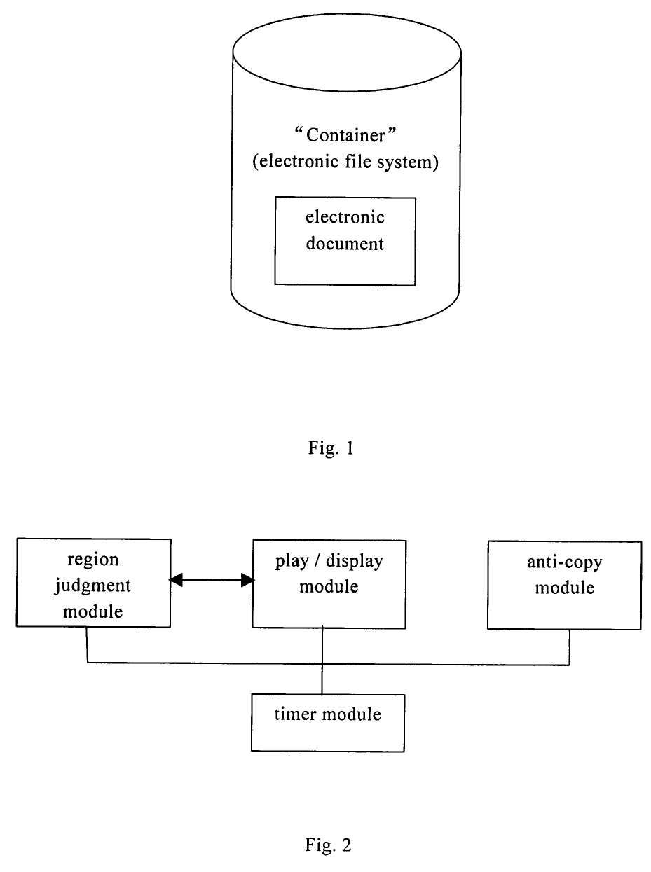

See FIG. 1, the basic idea is to encapsulate the original document into a virtual “container” system (i.e. our electronic file system) implemented by software. The document encapsulated within the “container” can't be extracted/copied out without cracking the system. At anytime, all the operations on the document have to be executed through the “container”.

What we need to clarify is, the “Document” mentioned above is the overall name for all digital files that contained some information. According to different environment, the “document” could be a MS Word file, a JPG file or other playable media files with the name like “xx.wmv”, etc. In the following, to simplify the wording, electronic documents are those digital files before getting encapsulated, while electronic files means the whole “container” system containing the encrypted and encapsulated documents.

Since the document is encapsulated inside a “container”, which appears also as an electronic file, the “container” could use the same icon or outlook as the original document, therefore the user will not be affected within the authorized region, and may not even feel the difference of using this encrypted “container” or the original document. Of course, the “container” can also use a different icon or outlook, or use some special attributes when displaying or playing the document, like the prompt that user may receive when opening a encrypted pdf file.

As in FIG. 2, the “container” contains:

Region judgment module, which is used to judge the current location of the document;

Play/display module, used to control the status of displaying or playing the document;

Anti-copy module, used to prevent any copy operation like “Print Screen” that the user may possibly do;

Timer module, used to trigger the above region judgment module and play/display module at the given recursive time points;

Among them, the region judgment module is connected with play/display module, and the timer module is connected with the above region judgment module, play/display module and anti-copy module.

During the running period, the region judgment module recursively (for example every 30 seconds or 1 minute) do the checking and judgment on the current location of the document, and sends the feedback to the play/display module. The play/display module will allow or disallow the displaying/playing the document according to the real time feedback from the region judgment module. If the feedback indicates that the document is still within the authorized region, the current displaying/playing is still allowed and will not be affected; if the feedback indicates that the document is out of the authorized region, the document will be disable to be displayed/played for the moment.

The anti-copy module will function all the time, whatever the document is within or out of the authorized region. Obviously, operations like “Print Screen” provided by the OS that may catch the display on the screen should be disabled.

The timer module sends the regular request to enforce the play/display module to verify the real time feedback from the region judgment module. When the document is within authorized region, the timer module will function in the background, and the user can't feel its existence. Once the location of the document has changed, especially out of the region, the timer module will function in the foreground. For example, in practice, files are always stored within the floating terminal devices such as laptops; therefore it is possible that user may carry the laptop moving into and out of one region to another region. Once the case appears, the play/display status of the document should be adjusted in real time. So, the timer module should send the request like every 30 seconds or 1 minute to enforce that the play/display module to call the region judgment module to verify the location information. If the region judgment module indicates that the document is now out of the authorized region, the play/display module should show some prompt on the screen, asking the user to return back to the region immediately, otherwise it will terminate the access of the document immediately or after short time duration.

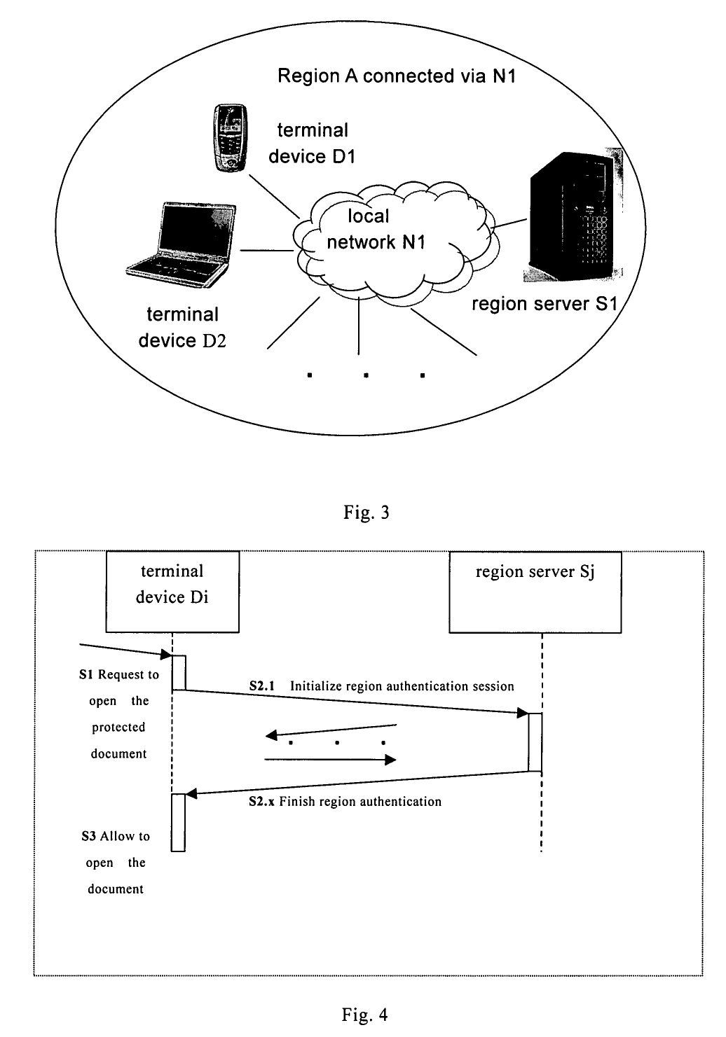

Another special point to be clarified is, the “region” presented in this invention is not a purely geographical concept, which should be understood as a defined set of access points, a local area network with security mechanism. The system acts as a virtual space that contains several authorized terminal devices, some region servers and some preset access points (e.g. IP addresses). As in FIG. 3, in this virtual space, there should be at least one region server and several terminal devices (D1, D2, etc.) that may be used to play or display the documents. Here, the terminal devices could be laptops, PDA or PC etc., while the region server could be a PC, switch or gateway server etc. The system could be based on the network connected by wired or wireless Local Network.

All authorized terminal devices should know the name/identifier of its region servers and the URL of the region servers; therefore they can exchange information with the region servers at any time. If PKI infrastructure is used, the terminal devices and the region servers should know each other's public key. Different terminal device is granted with different permissions, so as to control the documents stored on the terminal device. All authorized terminal devices can recognize/authenticate each other via existing security protocols.

In this system, any authorized terminal device should have a unique device identifier, such as Device ID number together with its MAC address etc., which is used by the region server to judge whether the terminal device is a authorized device belonging to some region, and whether the terminal device is currently within the region when the device identifier is combined with its current access point information.

Each time the terminal device connects to the local network, the region server records and checks the accessing information of the device such as device identifier and its IP address etc. Only after checking, and the device is determined to be connected locally (not via a proxy or VPN or any indirect way) and the device ID shows that the device is preset authorized device, the region server will send a nonce (a fresh random number for each new connection) to the terminal device. Moreover, these confidential information transmitted between the region server and the terminal device should be encrypted by the public key of the receiver and signed by the sender's private key. The certificate and the keys are used just by this application, but is not visible to any authorized users on the region server or the terminal device.

As in FIG. 4, the implementation of the invention adopts the method of access control; however it is the control on a portable package floating on different terminal devices, other then the access control within a closed information system as usual. Our encapsulated documents can be moved out of the secured local network, with security still guaranteed.

The invention is implemented via the combination of the above mentioned region server, terminal devices and the electronic file system encapsulating documents. As in FIG. 4, the solution contains following technical steps:

First, there is a document (encrypted) within terminal device Di requested to be opened, the play/display module first calls the region judgment module to judge the current location of the document. The region judgment module, after receiving the request, then initializes an authentication session between the terminal device Di and the target region server Sj.

Di first sends an authentication request, according to the agreed authentication protocol, to the region server Sj, containing Di's device identifier and its current access point (access address) information.

The authentication protocol could be any existing mature authentication protocols. The protocol could be tailored or extended to fit the required situation. The author would like to call the used protocol as the region authentication protocol and the authentication session as region authentication session. In this protocol, the device identifiers of the terminal devices and the region servers should contain the unique information that anyone can distinguish, for example, the terminal device Di could send the package encrypted by its own private key, so that the region server can verify if it is really sent by Di but not other pretenders. To challenge the server, the content could also be encrypted by the server's public key, so as no one but the right server can read the content.

Once Sj received the authentication request/challenge, according to the device identifier, the device's current access point information and the nonce (only if it is equal to the one the region server has sent to the terminal device for the current connection), it can determine whether Di is within Sj's own region, and it will generate the responses according to judgment result.

Once Di received the response, it will forward to the region judgment module. According to the response, the region judgment module will know whether the document is within the authorized region or not, and if Yes, it then notifies the play/display module to enable the document to be visible for the moment, otherwise it rejects the request to open the document.

During the opening state of the document (i.e., the document is being displayed or played), the timer module recursively sends the request to check and verify whether the terminal device is still within the authorized region, so as to ensure the encapsulated document will not be used and spread outside of the region.

More to clarify is, the current existing DRM technology also adopted the method of encapsulating the electronic documents. But the difference is, in DRM technology, device identifier or device's private information is used to verify and decrypt the document, and there is no way to restrict the location of the terminal device; which means, it doesn't care about where the terminal device will move to. In this invention, the device identifier is just used to identify whether the terminal device is authorized or not. To decrypt the encapsulated document, the current access point or the current address like IP will be used to judge the current location of the terminal device, and there is a nonce is also required to check if the connection is local. Only when the authorized terminal device is locally within the authorized region, the document can be allowed to be played or displayed.

The above technique solution can be implemented via the existing technologies. For example, the core point of region judgment module is to recognize and manage the device identifiers, current access points and the response from the region server, etc. The core point of the play/display module lies in control and management of memory. Take the popular MS Word document as an example, the above functional modules can be implemented via calling API provided by Microsoft Corporation. The technology of encapsulating documents within a “container” can refer to the implementation of those DRM implementations, so as to ensure the security of the documents.

In view of the many possible embodiments to which the principles of this invention may be applied, it should be recognized that the embodiment described herein with respect to the drawing figures is meant to be illustrative only and should not be taken as limiting the scope of invention. For example, those of skill in the art will recognize that the elements of the illustrated embodiment shown in software may be implemented in hardware and vice versa or that the illustrated embodiment can be modified in arrangement and detail without departing from the spirit of the invention. Therefore, the invention as described herein contemplates all such embodiments as may come within the scope of the following claims and equivalents thereof.

1. An electronic file system, in which a document is encapsulated, comprising:
a region judgment module, for judging the current location of the system; and
a play/display module, for controlling a status of playing or displaying the document;
wherein,
the region judgment module is connected with the play/display module, when the region judgment module detects that the system is not within a preset authorized region, it notifies the play/display module to reject or stop the access of the document.

2. The electronic file system according to claim 1, further comprising an anti-copy module that could prevent from copying operations.

3. The electronic file system according to claim 1, further comprising a timer module that could trigger the region judgment module and play/display module at a given time points;
the timer module is connected with the said region judgment module, play/display module and anti-copy module.

4. The electronic file system according to claim 1, wherein the preset authorized region is a preset local area network.

5. A region-based controlling system for electronic documents, comprising:
at least one region server and many terminal devices connected with the at least one region server, the terminal device storing the electronic file systems of claim 1;
the region judgment module communicates with the region server via the terminal device;
the region server identifies and judges whether the terminal device is an authorized device that locates in the preset authorized region, with a device identifier and a current access address of the terminal device;
the preset region is a preset local network area.

6. A region-based controlling method for electronic documents based on the system of claim 1, the method comprising:
a step for encapsulating the document to be protected within the electronic file system;
a step for the region server to identify the terminal device as an authorized device located in the preset authorized region every time the terminal device connects the region server, and then transmitting a fresh nonce to the terminal device, the region server identifying the terminal device as an authorized device with the device identifier and current access address;
a step for the play/display module to request the region judgment module to verify the current location of the terminal device when the document is to be played or displayed;
a step for the region judgment module to send a region authentication request via the terminal device to the region server, the region authentication request including the device identifier, current access address and the fresh nonce;
a step for the region server to verify the terminal device as an authorized device in the preset authorized region with the device identifier and the current access address, and to check if the fresh nonce received from the terminal device matches the fresh nonce sent from the region server to the terminal device, and to send a response for confirming that the terminal device is located in the preset authorized region if the received fresh nonce matches;
a step for the region judgment module to notify the play/display module to play or display the content of the document when the response for confirming that the terminal device is located in the preset authorized region is received.

7. A region-based controlling method for electronic documents according to claim 6, wherein message between the region server and the terminal devices is encrypted by a public key corresponding to a part which receives the message and signed by a private key corresponding to a part which sends the message.

8. A region-based controlling method for electronic documents according to claim 6, wherein the document is prevented from being copied when the document is being played or displayed.

9. A region-based controlling method for electronic documents according to claim 6, wherein the play/display module is requested by the timer module to verify the response from the region judgment module at the given time point.

10. A region-based controlling method for electronic documents according to claim 6, wherein the play/display module is notified by the region judgment module that the terminal device is now out of the authorized region; the play/display module notifies a user of the terminal device that the terminal device is out of the authorized region or the document being played or displayed is about to be closed, otherwise, directly closes the document being played or displayed.
